(19) United States
(12) Patent Application Publication
(10) Pub. No.: US 2005/0250003 A1
(43) Pub. Date: Nov. 10, 2005

(54) ELECTROCHEMICAL CELL SUPPORT STRUCTURE

(75) Inventors: John Zagaja, East Granby, CT (US); Dave Christensen, Harwinton, CT (US); Durwood Beringer, Windsor, CT (US); Tushar Ghuwalewala, Wethersfield, CT (US); Chris Capuano, Windsor Locks, CT (US); Tony Hurtado, Guilford, CT (US)

Correspondence Address: CANTOR COLBURN, LLP, 55 GRIFFIN ROAD SOUTH, BLOOMFIELD, CT, 06002, US

(73) Assignee: PROTON ENERGY SYSTEMS, INC., Wallingford, CT (US)

(21) Appl. No.: 10/604,670

(22) Filed: Aug. 8, 2003

Related U.S. Application Data
(60) Provisional application No. 60/402,414, filed on Aug. 9, 2002.

(51) Int. Cl. H01M 4/86; H01M 8/10; C25B 11/03; C25B 1/10

(52) U.S. Cl. 429/45; 429/13; 204/284; 204/266; 429/30

(57) ABSTRACT

An electrochemical cell can comprise: a first electrode and a second electrode with a membrane disposed therebetween and in ionic communication with the first electrode and the second electrode and a sintered porous support member disposed on a side of the membrane opposite the second electrode, wherein the support member comprises a first portion on first side of the support member proximate the membrane and a second portion disposed on a side of the first portion opposite the membrane, wherein the second portion has a second portion porosity different from a first portion porosity.

### CROSS REFERENCE TO RELATED APPLICATIONS

This application claims the benefit of the filing date of U.S. Provisional Application Ser. No. 60/402,414, filed on Aug. 9, 2002, which is hereby incorporated by reference.

### BACKGROUND

This disclosure relates to electrochemical cell systems, and, more particularly, to an electrochemical cell in which the flow field support structures comprise porous plates that enable high pressures to be maintained across the cell.

Electrochemical cells are energy conversion devices, usually classified as either electrolysis cells or fuel cells. Proton exchange membrane electrolysis cells can function as hydrogen generators by electrolytically decomposing water to produce hydrogen and oxygen gases. Referring to FIG. 1, a section of an anode feed electrolysis cell of the prior art is shown generally at 10 and is hereinafter referred to as “cell 10.” Reactant water 12 is fed into cell 10 at an oxygen electrode (anode) 14 to form oxygen gas 16, electrons, and hydrogen ions (protons) 15. The chemical reaction is facilitated by the positive terminal of a power source 18 connected to anode 14 and the negative terminal of power source 18 connected to a hydrogen electrode (cathode) 20. Oxygen gas 16 and a first portion 22 of the water are discharged from cell 10, while protons 15 and a second portion 24 of the water migrate across a proton exchange membrane 26 to cathode 20. At cathode 20, hydrogen gas 28 is removed, generally through a gas delivery line. The removed hydrogen gas 28 is usable in a myriad of different applications. Second portion 24 of water is also removed from cathode 20.

An electrolysis cell system may include a number of individual cells arranged in a stack with reactant water being directed through the cells via input and output conduits formed within the stack structure. The cells within the stack are sequentially arranged, and each one includes a membrane electrode assembly (MEA) defined by a proton exchange membrane disposed between a cathode and an anode. The cathode, anode, or both may be gas diffusion electrodes that facilitate gas diffusion to the proton exchange membrane. Each membrane electrode assembly is in fluid communication with flow fields adjacent to the membrane electrode assembly, defined by structures configured to facilitate fluid movement and membrane hydration within each individual cell.

The portion of water discharged from the cathode side of the cell, which is entrained with hydrogen gas, is fed to a phase separator to separate the hydrogen gas from the water, thereby increasing the hydrogen gas yield and the overall efficiency of the cell in general. The removed hydrogen gas may be fed either to a dryer for removal of trace water, to a storage facility, e.g., a cylinder, a tank, or a similar type of containment vessel, or directly to an application for use as a fuel.

Another type of water electrolysis cell that utilizes the same configuration as is shown in FIG. 1 is a cathode feed cell. In the cathode feed cell, process water is fed on the side of the hydrogen electrode. A portion of the water migrates from the cathode across the membrane to the anode. A power source connected across the anode and the cathode facilitates a chemical reaction that generates hydrogen ions and oxygen gas. Excess process water exits the cell at the cathode side without passing through the membrane.

A typical fuel cell also utilizes the same general configuration as is shown in FIG. 1. Hydrogen gas is introduced to the hydrogen electrode (the anode in the fuel cell), while oxygen, or an oxygen-containing gas such as air, is introduced to the oxygen electrode (the cathode in the fuel cell). The hydrogen gas for fuel cell operation can originate from a pure hydrogen source, a hydrocarbon, methanol, or any other source that supplies hydrogen at a purity level suitable for fuel cell operation. Hydrogen gas electrochemically reacts at the anode to produce protons and electrons, the electrons flow from the anode through an electrically connected external load, and the protons migrate through the membrane to the cathode. At the cathode, the protons and electrons react with oxygen to form water.

A typical cell system that can be utilized with other cells and incorporated into a stack structure is shown at 30 with reference to FIG. 2. Cell system 30 comprises an MEA defined by a proton exchange membrane 32 having a first electrode (e.g., an anode) 34 and a second electrode (e.g., a cathode) 36 disposed on opposing sides thereof. Regions proximate to and bounded on at least one side by anode 34 and cathode 36 respectively define flow fields 38, 40. On the anode side of the MEA, a flow field support member 42 may be disposed adjacent to anode 34 to facilitate membrane hydration and/or fluid movement to the membrane. Flow field support member 42, which is typically a wire mesh structure, is retained within flow field 38 by a frame 44 and a cell separator plate 48. A gasket 46 is optionally positioned between frame 44 and cell separator plate 48 to effectively seal flow field 38. On the cathode side of the MEA, a flow field support member 50 (which is also typically a wire mesh structure) may be disposed adjacent to cathode 36 to further facilitate membrane hydration and/or fluid movement to the membrane.

A pressure pad 52 is typically disposed between flow field support member 50 and a cell separator plate 54. A pressure pad separator plate 62 may be disposed between pressure pad 52 and flow field support member 50. Pressure pads may be disposed on either or both sides of membrane 32 and may be positioned within either or both of the flow fields of cell system 30. One or more pressure plates 60 may optionally be disposed adjacent to pressure pad 52 to distribute the pressure exerted on pressure pad 52 and increase the pressure within the cell environment. Flow field support member 50 and pressure pad 52 (as well as optional pressure plates 60) are retained within flow field 40 by a frame 56 and cell separator plate 54. A gasket 58 is optionally positioned between frame 56 and cell separator plate 54 to effectively seal flow field 40. The cell components, particularly frames 44, 56, cell separator plates 48, 54, and gaskets 46, 58, are formed with the suitable manifolds or other conduits to facilitate fluid communication through cell system 30.

Under high pressure operating conditions, flow field support members 42, 50 oftentimes do not provide the necessary structural integrity to the MEA. For example, during operation of a cell in which a differential pressure across the MEA exceeds about 400 pounds per square inch (psi), the ion exchange membrane from which the MEA is fabricated can extrude into the screen mesh on the side of the MEA having the lower pressure, thereby potentially causing a malfunction of cell system 30. Moreover, and because the screens are characterized by a structure having a relatively large mesh size, flow through the screen is oftentimes directed in channels from the inlet to the outlet such a less-than-uniform distribution of fluid is effected across the support structure (and thus across the cross-section of the cell to the electrode).

While existing electrolysis cell systems are suitable for their intended purposes, there still remains a need for improvements. Some of the improvements needed include the use of flow field support members of sufficient structural integrity to withstand high pressures associated with the operation of the cell systems and the provision of the uniform distribution of flow across the cell.

### BRIEF SUMMARY

Disclosed herein are electrochemical cells and methods for using the same. In one embodiment, the electrochemical cell comprises: a first electrode and a second electrode with a membrane disposed therebetween and in ionic communication with the first electrode and the second electrode and a sintered porous support member disposed on a side of the membrane opposite the second electrode, wherein the support member comprises a first portion on first side of the support member proximate the membrane and a second portion disposed on a side of the first portion opposite the membrane, wherein the second portion has a second portion porosity different from a first portion porosity.

In another embodiment, the An electrochemical cell, comprising: a first electrode and a second electrode with a membrane disposed therebetween and in ionic communication with the first electrode and the second electrode, a flow field consisting essentially of a porous support member disposed in electrical and physical communication with the first electrode, wherein the porous support member comprises a channel, and a pressure assembly disposed in physical and electrical communication with the flow field.

In one embodiment, the method for operating the electrochemical cell comprises: passing water through a sintered porous support member to a first electrode, producing hydrogen ions and oxygen, moving the hydrogen ions across a membrane to a second electrode, wherein there is a pressure differential across the membrane of greater than or equal to about 100 psi, and forming hydrogen gas at the second electrode. The support member can be disposed on a side of the membrane opposite the second electrode, wherein the support member comprises a first portion on first side of the support member proximate the membrane and a second portion disposed on a side of the first portion opposite the membrane, and wherein the second portion has a second portion porosity different from a first portion porosity.

In another embodiment, the method for operating an electrochemical cell comprises: passing water through a flow field to a first electrode, producing hydrogen ions and oxygen, moving the hydrogen ions across a membrane to a second electrode, wherein there is a pressure differential across the membrane of greater than or equal to about 100 psi, and forming hydrogen gas at the second electrode. The flow field consists essentially of a sintered porous support member disposed in electrical and physical communication with the first electrode, and a pressure assembly is disposed in physical and electrical communication with the flow field.

The above described and other features are exemplified by the following figures and detailed description.

### BRIEF DESCRIPTION OF THE DRAWINGS

Referring now to the drawings wherein like elements are numbered alike in several Figures:

FIG. 1 is a schematic representation of an anode feed electrolysis cell of the prior art;

FIG. 2 is a schematic representation of a cell system of the prior art;

FIG. 3 is a cross-sectional side view of a schematic representation of a cell system having porous support members;

FIG. 4 is a plan view of one embodiment of a first layer of a porous support member;

FIG. 5 is a plan view of another embodiment of a first layer of a porous support member in which channels extend across the porous support member;

FIG. 6 is a plan view of another embodiment of a first layer of a porous support member in which a channel indirectly extends across the face of the porous support member to an outlet;

FIGS. 7 and 8 are cross-sectional views of the porous support member of FIG. 6;

FIG. 9 is a plan view of the second layer of a porous support member having areas of higher porosity and areas of lower porosity;

FIG. 10 is a perspective view of an alternate embodiment of a porous support member;

FIG. 11 is a schematic view of a cell system having a porous support member disposed at the oxygen side of the cell; and

FIG. 12 is a schematic view of a cell system having a porous support member disposed at the hydrogen side of the cell.

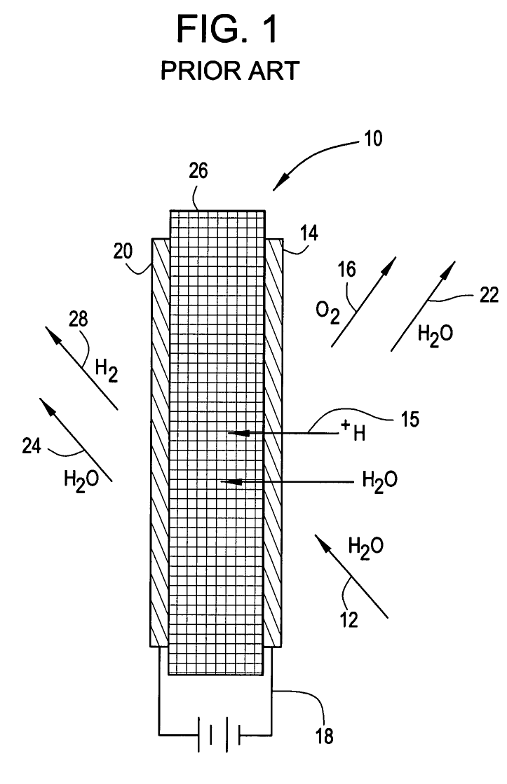

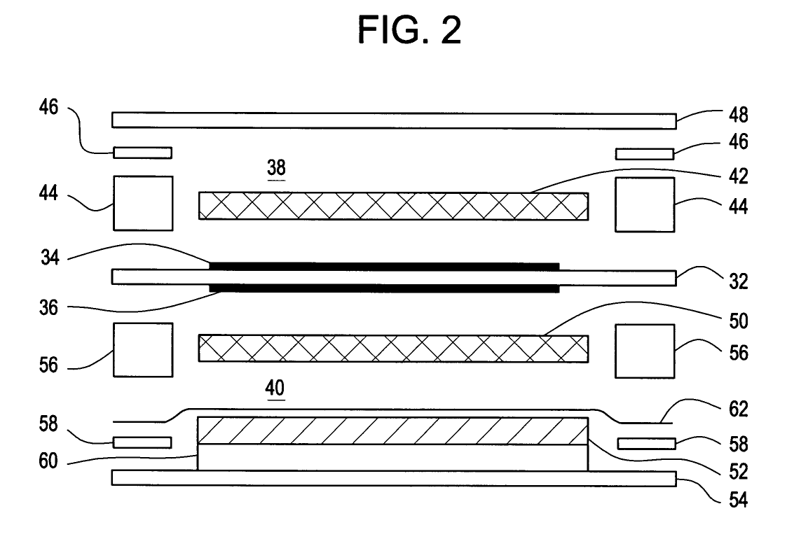

### DETAILED DESCRIPTION

Disclosed herein is a support structure for an electrochemical cell, which can serve as both a membrane support and the flow field. The cell into which the support structure may be incorporated may be operated as an electrolysis cell and/or a fuel cell. While the discussion below is directed to an anode feed electrolysis cell, however, it should be understood that cathode feed electrolysis cells, fuel cells, and regenerative fuel cells are also within the scope of the embodiments disclosed.

A cell stack is formed of a plurality of individual cells and includes flow field support structures disposed in the flow fields at opposing sides of a membrane electrode assembly (MEA) comprising a membrane and electrodes. One of the electrodes provides reactive sites for the electrolysis of water, with one or more of the electrodes optionally comprising a porous catalytic structure. The flow field support structures are porous members (e.g., sintered porous support members), generally in the form of plates, that are disposed within the flow fields such that the members are adjacent to and in electrical contact with an electrode and a boundary surface defined by either a cell separator plate, a pressure pad, a screen pack (e.g., an additional flow field), or a pressure pad separator plate. Optionally, the electrode can be disposed in the porous support member, either throughout the member or mostly on the side of the member disposed proximate the membrane.

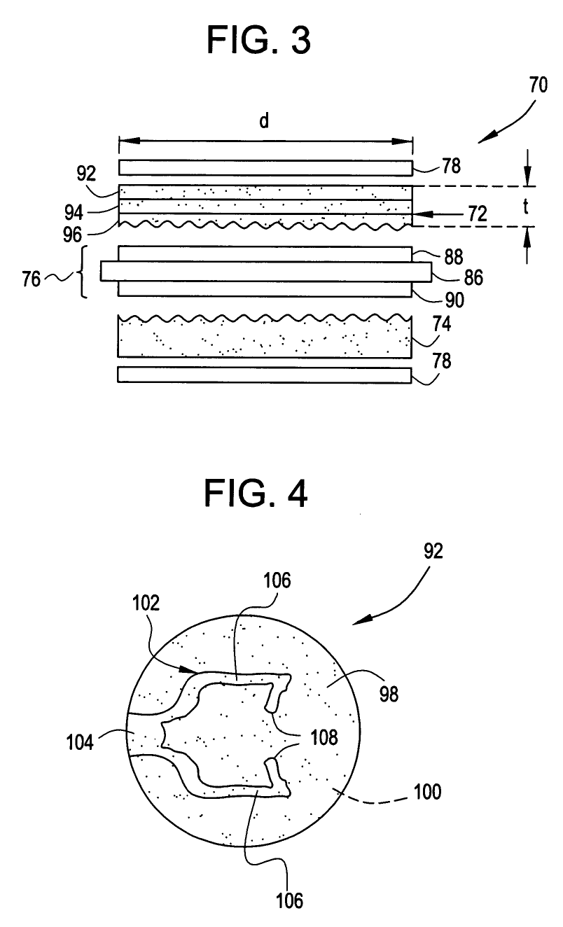

Referring now to FIG. 3, illustrated is an exemplary cell of a cell stack 70 (hereinafter referred to as “cell 70”), incorporating a porous plate support member 72. A stack into which cell 70 is incorporated can include a plurality of cells employed as part of the cell system. When used as an electrolysis cell, voltage inputs are generally about 1.48 volts to about 3.0 volts or so, with current densities of about 50 A/ft² (amperes per square foot) to about 4,000 A/ft². When cell 70 is utilized as a fuel cell, power outputs are dependent upon the number of cells. Typically, the outputs are about 0.4 volts to about 1 volt, with current densities being about 0.1 A/ft² to about 10,000 A/ft². Current densities exceeding 10,000 A/ft² may also be obtained depending upon the fuel cell dimensions and configuration. The number of cells within the stack and the dimensions of the individual cells is scalable to the gas output and/or the cell power output requirements. Differential pressures at which cell 70 is operated may be greater than or equal to about 500 psi, greater than or equal to about 1,000 psi, and even greater than or equal to about 10,000 psi.

Cell 70 comprises a porous plate support member 72 disposed at an MEA 76 of cell 70. Optionally, cell 70 may further include a porous plate support member 74 disposed at the opposing side of cell 70, as is shown, with a pressure pad 78 disposed adjacent one or both of the support members 72,74, and an optional pressure pad separator plate (not shown) disposed between the pressure pad 78 and the adjacent support member (72/74). MEA 76 comprises a proton exchange membrane 86 and the electrodes (anode 88 and cathode 90) disposed at opposing sides of proton exchange membrane 86. As shown, both anode 88 and cathode 90 are positioned in contact (e.g., ionic communication) with the surface of proton exchange membrane 86 within the active areas, which are defined as the areas of an electrolysis cell at which the dissociation of water and production of an oxygen gas stream and/or a hydrogen gas stream.

Membrane 86 comprises electrolytes that are preferably solids under the operating conditions of the electrochemical cell. Useful materials from which membrane 86 can be fabricated include proton conducting ionomers and ion exchange resins. Useful proton conducting ionomers include complexes comprising an alkali metal salt, an alkali earth metal salt, a protonic acid, a protonic acid salt, or the like, as well as combinations at least one of the foregoing materials. Counter-ions useful in the above salts include halogen ion, perchloric ion, thiocyanate ion, trifluoromethane sulfonic ion, borofluoric ion, and the like, as well as combinations comprising at least one of the foregoing materials. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like, as well as combinations comprising at least one of the foregoing materials. The alkali metal salt, alkali earth metal salt, protonic acid, or protonic acid salt is complexed with one or more polar polymers such as a polyether, polyester, or polyimide, or with a network or cross-linked polymer containing the above polar polymer or combination of polymers as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid, exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinyl-benzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins can include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids, and bases. One family of fluorocarbon-type resins having sulfonic acid group functionality is NAFION® resins (commercially available from E.I. du Pont de Nemours and Company, Wilmington, Del.).

Anode 88 and cathode 90 are fabricated from catalytic materials suitable for performing the needed electrochemical reaction (e.g., electrolyzing water to produce hydrogen and oxygen). Suitable catalytic materials for anode 88 and cathode 90 include, but are not limited to, platinum, palladium, rhodium, carbon, gold, tantalum, tungsten, ruthenium, iridium, osmium, and the like, as well as alloys and combinations comprising at least one of the foregoing materials. Anode 88 and cathode 90 are positioned adjacent to and in ionic communication with membrane 86 and defined by structures comprising discrete catalytic particles adsorbed onto a porous substrate. Adsorption of the catalytic particles onto the substrate may be by any method including, but not limited to, spraying, dipping, painting, imbibing, vapor depositing, combinations comprising at least one of the foregoing methods, and the like. Alternately, the catalytic particles may be deposited directly onto opposing sides of membrane 86 or in/onto porous plate support members 72, 74.

Porous support member 72 is defined by a thickness t and at least one lengthwise dimension d such that porous support member 72 occupies substantially all of the volume of the cavity defining the flow field. Although only porous support member 72 is described, a porous support member 74 should be understood to be substantially similar in construction. It is noted, however, that the design of each of the porous support members is determined independently of the other porous support member (e.g., one or more of the members may comprise multiple layers, a porosity gradient(s), channel(s), areas of higher and lower porosity, as well as combinations comprising at least one of these designs).

The geometry and composition of the porous support member 72 can vary depending upon the particular type and geometry of the electrochemical cell in which the porous support member 72 is utilized. The geometry of porous support member 72 is preferably such that the porous support member 72 can be retained within the frames of an electrolysis cell. With respect to composition, the porous plate member 72 is preferably fabricated of a material such that electrical communication can be maintained between opposing surfaces of porous plate support member 72 and across cell 70. Materials from which the plates may be fabricated include metals such as sintered metals. Possible metals include, but are not limited to, titanium, niobium, zirconium, carbon, hafnium, iron, cobalt, nickel, and the like, as well as alloys and combinations comprising at least one of the foregoing materials, such as nickel alloys, iron alloys (e.g., steels such as stainless steels and the like), cobalt alloys, and the like. Various material forms can also be employed, including fibrous (e.g., random, woven, non-woven, chopped, continuous, and the like), granular, particulate powder, combinations comprising at least one of the foregoing forms, and the like. Alternately, the materials may be in the forms of fibrous felts, woven- or unwoven screens, combinations comprising at least one of the foregoing forms, and the like.

In the embodiment illustrated in FIG. 3, the porous support member 72 comprises any number of individual portions (while porous support member 74 is illustrated as a single portion). These portions can be separate layers or merely portions of a single layer. In one exemplary embodiment, porous support member 72 comprises a plurality of layers arranged (e.g., stacked) such that a major face of one layer engages and registers with the major face of an adjacently positioned layer. Each layer of porous support member 72 is about 35% to about 75% porous, and is preferably about 40% to about 65% porous. The individual layers of the porous plate support member 72 may be about 0.1 millimeters (mm) to about 0.5 mm in thickness (e.g., about 0.25 mm in thickness), while the overall thickness of the porous plate support member 72 can be about 0.25 mm to about 3 mm (e.g., an overall thickness of about 2.5 mm).

The manufacture of a porous support member comprises sintering a layer of electrically conductive material to form a porous support. Depending upon the desired design of the porous support member, the sintered layer can have a substantially uniform porosity throughout, a porosity gradient (e.g., from one side toward another where the area of lowest porosity can be on a side of the porous support member or within (e.g., toward the center) thereof), and/or areas of higher and lower porosity (wherein porosity is the pore volume versus the total volume of that portion). If multiple layers form the porous support member, each portion 92, 94, 96 is maintained in electrical communication with its adjacent portion. Maintenance of electrical communication can be by various techniques, some exemplary techniques include bonding (e.g., diffusion bonding), welding (e.g., spot- or tack welding), pressure, and the like.

In still another embodiment, a single sintered porous support member can be manufactured such that a higher density region can be formed at a surface of the substrate disposed proximate the membrane (e.g., adjacent to and in contact with the electrode). A porous plate support member having such a higher density region adjacent to the membrane provides added support to the membrane (note, the electrode can be disposed on/within the porous support member and/or on the membrane, between the porous support member and the membrane).

One exemplary multi-plate configuration of porous plate member 72 comprises an optional first portion (e.g., the side of the porous support member opposite the membrane side) 92 (e.g., portion of a single layer or the entire layer) having a first portion density, a second portion 94 (e.g., the inside portion of the porous support member or the side opposite the membrane side if no third portion exists) having a second portion density different from the first portion density (i.e., a different porosity). For example, the second portion density can be lower than, equal to, or greater than the first portion density, and a third portion (e.g., the membrane side portion) 96 can have a third portion density that is greater than the second portion density, with a density commensurate with the first portion density possible. For example, the first portion porosity can be equal to either the second portion porosity, the third portion porosity, or can be different. The third portion porosity can be less than or equal to about 60%, e.g., about 35% to about 50%. The second portion porosity can be greater than or equal to about 50%, e.g., about 50% to about 70%, and the first portion porosity can be greater than or equal to about 35%, e.g., about 35% to about 70%.

Referring now to FIG. 4, first portion 92 is shown. Although the geometry of first portion 92 is shown as being circular across a major face thereof, the geometry may be any configuration that corresponds with the inner volume defined as the working area of the cell. Other configurations include, but are not limited to, rectangular, hexagonal, octagonal, and the like. First portion 92 includes a first major surface 98 and an opposing second major surface 100. First major surface 98 may be textured such that during operation of a cell into which the porous plate support member is incorporated, a flow of fluid is affected that simulates the fluid flow characteristic of a desired flow field. Such a flow serves to hydrate the membrane while providing adequate electrical communication and optionally cooling through the cell. The texturing may comprise a channel 102, as is shown, disposed in an upper surface thereof. Preferably, the texturing is disposed in first major surface 100 via an embossing technique, although other methods (e.g., shaving, grinding, and the like) may be utilized. Channel 102 includes an inlet 104 and at least two legs 106 extending from inlet 104. Inlet 104 receives a water stream from a water supply (not shown) and distributes the water to legs 106. Each leg 106 is embossed or otherwise formed in first major surface 98 and extends across first major surface 98 to diste tribute the water received across the face. Each leg 106 further includes a terminus 108 positioned proximate the geometric center of first major surface 98. By distributing water directly to the center of first major surface 98, a more uniform diffusion of the water can be facilitated through first portion 92 to the electrode and to an outlet (not shown) disposed within the cell frame.

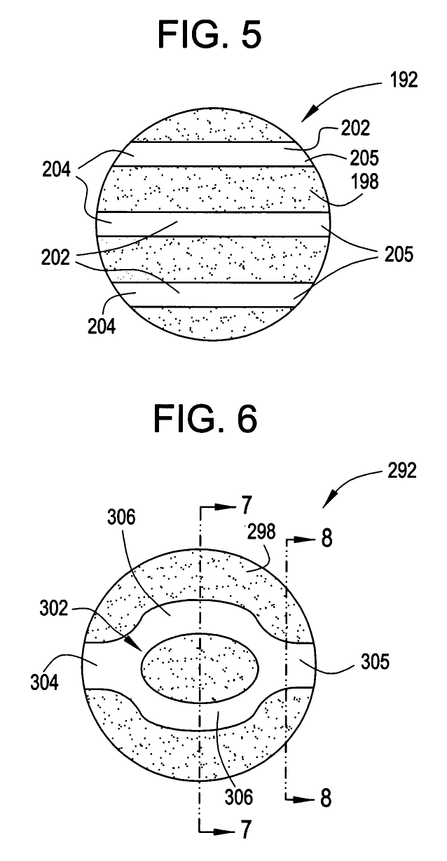

Referring now to FIG. 5, another exemplary embodiment of a first portion is shown at 192. First portion 192 includes a first major surface 198 and an opposing second major surface (not shown). First major surface 198 is textured with parallel chordal channels 202 extending across first major surface 198 between inlets 204 and outlets 205. By configuring channels 202 to extend directly between inlets 204 and outlets 205, an improved cooling rate is realized by the cell into which first plate 192 is incorporated. Preferably channels 202 are disposed in first major surface 198, e.g., via an embossing technique.

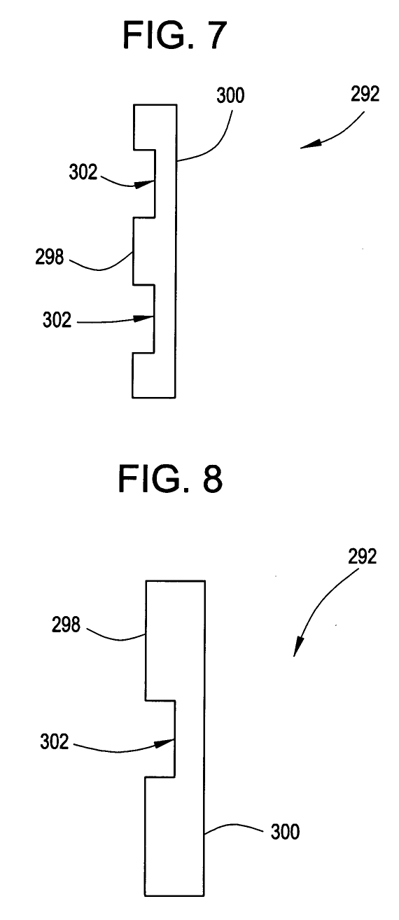

Referring to FIGS. 6 through 8, another exemplary embodiment of a first plate is shown at 292. First portion 292 includes a first major surface 298 and an opposing second major surface 300. First major surface 298 is textured with a channel 302 that extends from an inlet 304 and is preferably broken into two legs 306 such that water flowing therethrough is diverted across first major surface 298. Although FIGS. 6 and 7 illustrate channel 302 as having two legs 306, any number of legs 306 may extend from inlet 304. As shown in FIG. 6, legs 306 redirect the flow of water back to an outlet 305 disposed at the edge of first portion 292 opposite the edge at which inlet 304 is disposed.

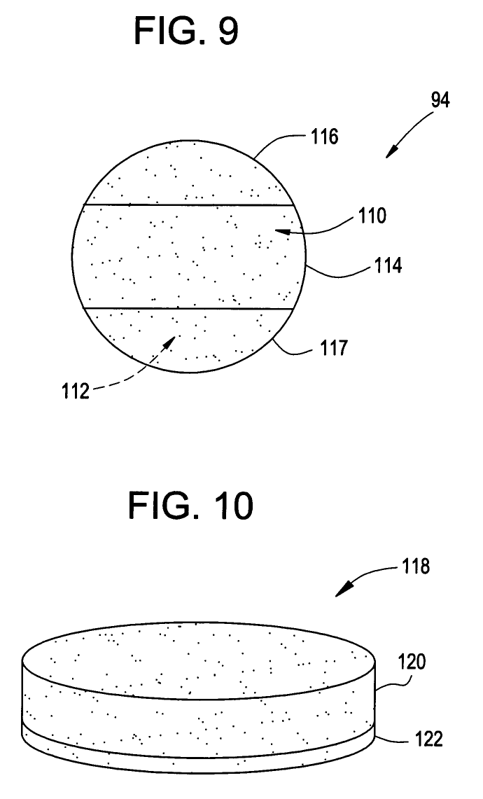

Second portion 94 is shown with reference to FIG. 9. In the three-portion configuration, second portion 94 is arranged such that a first major surface 110 thereof engages and registers with the second major surface of the first portion. An opposing second major surface 112 of second portion 94 defines a lower surface. In one exemplary embodiment, as is shown, second portion 94 is of variable density, and thus, variable porosity, density being inversely proportional to porosity. In this embodiment, because the average density of second portion 94 is less than the first portion (and more porous), the uniform distribution of water second portion 94 is efficiently achieved. Furthermore, because second portion 94 is less dense (and more porous) than either the first portion or the third portion, the efficient fluid communication through second portion 94 provides adequate cooling for cell 70 during its operation.

In the exemplary embodiment in which second portion 94 (which can comprise a uniform density) is of a variable density, second portion 94 comprises a region 114 of high density material that extends, for example, from a point at an edge of second portion 94 that corresponds to the inlet to a point at the edge of second portion 94 that corresponds to the outlet. The high density material has a porosity of greater than or equal to about 50%, preferably about 50% to about 60%, and more preferably about 50%. Disposed along edges of region 114 are a first region 116 of lower density material and a second region 117 of lower density material. The lower density material has a porosity of greater than or equal to about 60%, which allows for a higher flow rate of water through the cell, thereby providing for increased cooling capacity within the cell. It is understood that the use of the variable density can be used in conjunction with, or as an alternative to, the use of channel(s) (e.g., in second portion 94 and/or in first portion 92). If the second portion 94 is disposed on the side of the porous support member 72 opposite the membrane side, the second portion 92 may have the channel configurations discussed above for the first portion 92. Additionally, even if the first portion 92 is employed, the second portion 94 may comprise channels and/or regions of higher and lower porosity to facilitate fluid transfer and/or cell cooling.

Referring now to FIGS. 3, 4, and 9, third portion 96 comprises a first major surface and an opposing second major surface. The first major surface of third portion 96 engages and registers with second major surface 112 defined by the lower surface of second portion 94. The second major surface of third portion 96 engages and preferably registers with anode 88 and/or the membrane (e.g., if the third portion comprises the anode). Third portion 96 is preferably uniformly dense and about 35% to about 50% porous. The mean pore size of the pores of third portion 96 may be about 7 micrometers to about 10 micrometers. The higher density of third portion 96 provides structural support to MEA 76 during operation of cell 70.

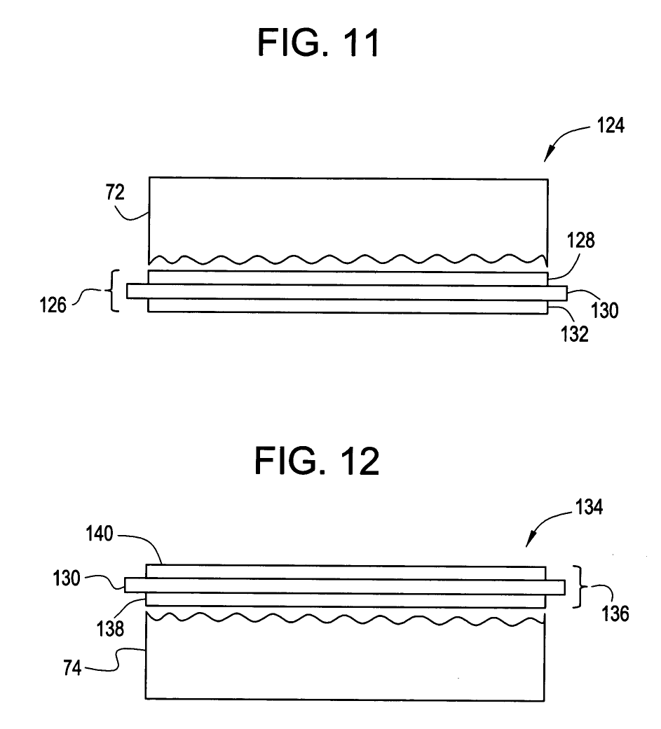

Various combinations of support members may also be incorporated into an electrochemical cell configuration. In particular, porous support member 72 may be disposed at an oxygen side of an electrolysis cell 70 in which anode 88 is disposed at the oxygen side of membrane 86, cathode 90 is disposed at a hydrogen side of membrane 86, and porous plate support member 74 is disposed at cathode 90 at the hydrogen side of cell 70, as is shown in FIG. 3 (both electrodes, individually, may be disposed on/within the appropriate support member). Porous support member 72 may also be disposed at the oxygen side of an electrolysis cell 124 in which an MEA 126 includes an oxygen catalyst layer 128 disposed at a membrane 130 without a hydrogen catalyst layer, and in which a porous hydrogen electrode 132 is disposed at the hydrogen side of electrolysis cell 124, as is shown in FIG. 11. Alternately, porous support member 74 may be disposed at the hydrogen side of an electrolysis cell 134 in which an MEA 136 includes a hydrogen catalyst layer 138 disposed at membrane 130 without an oxygen catalyst layer, and in which a porous oxygen electrode 140 is disposed at the oxygen side of electrolysis cell 134, as is shown in FIG. 12.

In any embodiment, elimination of other types of flow field support structures (e.g., screen packs and the like) and their replacement with the above-described porous support members, at either or both sides of the cell, enable the cell to operate at high pressures (e.g., at about 500 psi or greater) without deformation of the support structures. Furthermore, the incorporation of the porous support members imparts an improved structural integrity to the cell, which thereby allows the cell to be operated more efficiently under pressure of about 100 psi to about 300 psi and more.

A method for operating an electrochemical cell with the porous support members can comprise passing water through a sintered porous support member to a first electrode to produce hydrogen ions and oxygen. The hydrogen ions are moved across the membrane to a second electrode where hydrogen gas is formed at the second electrode. Preferably, the pressure differential across the membrane is greater than or equal to about 100 psi, with greater than or equal to about 500 psi, and even greater.

A method of hydrating an electrode of an electrochemical cell can comprise receiving a fluid stream at a first layer of a porous support member, diffusing fluid from a fluid stream through a first layer to a second layer of the porous support member, and diffusing fluid from the second layer to the electrode. The diffusing of the fluid from the second layer to the electrode comprises diffusing fluid through a third layer of the porous support member.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the disclosure.

1. An electrochemical cell, comprising:
a first electrode and a second electrode with a membrane disposed therebetween and in ionic communication with the first electrode and the second electrode; and
a sintered porous support member disposed on a side of the membrane opposite the second electrode, wherein the support member comprises a first portion on first side of the support member proximate the membrane and a second portion disposed on a side of the first portion opposite the membrane, wherein the second portion has a second portion porosity different from a first portion porosity.

2. The electrochemical cell of claim 1, wherein the second portion porosity is greater than the first portion porosity.

3. The electrochemical cell of claim 2, wherein the first portion porosity is less than or equal to about 60%.

4. The electrochemical cell of claim 3, wherein the first portion porosity is about 35% to about 50%.

5. The electrochemical cell of claim 2, wherein the second portion porosity is greater than or equal to about 50%.

6. The electrochemical cell of claim 5, wherein the second portion porosity is about 50% to about 70%.

7. The electrochemical cell of claim 1, wherein the support member comprises a third portion disposed on a side of the second portion opposite the first portion, wherein the third portion has a third portion porosity that is less than or equal to the second portion porosity.

8. The electrochemical cell of claim 1, wherein the support member comprises a plurality of layers, wherein each layer has a layer porosity of greater than or equal to a previous layer.

9. The electrochemical cell of claim 1, wherein the support member is a single layer comprising a decreasing porosity gradient from the first side toward a second side disposed opposite the first side.

10. The electrochemical cell of claim 1, wherein the support member further comprises a second side comprising a channel.

11. The electrochemical cell of claim 10, wherein the channel extends from an inlet disposed proximate an edge of the side to a terminus disposed proximate a geometric center of the side.

12. The electrochemical cell of claim 10, wherein the channel extends from an inlet disposed proximate an edge of the side to an outlet disposed proximate the same or a different edge of the side.

13. The electrochemical cell of claim 1, wherein the second portion comprises higher porosity regions and lower porosity regions.

14. The electrochemical cell of claim 1, further comprising a pressure pad disposed in physical and electrical communication with the support member.

15. The electrochemical cell of claim 1, further comprising an additional sintered porous support member disposed on a side of the membrane opposite the support member.

16. The electrochemical cell of claim 15, wherein the additional support member comprises the second electrode.

17. The electrochemical cell of claim 15, wherein the additional support member further comprises a first additional portion on first side of the additional support member proximate the membrane and a second additional portion disposed on a side of the first additional portion opposite the membrane, wherein the second additional portion has a second additional portion porosity different from a first additional portion porosity.

18. The electrochemical cell of claim 17, wherein the second additional portion porosity is greater than the first additional portion porosity.

19. The electrochemical cell of claim 1, wherein the support member further comprises the first electrode.

20. An electrochemical cell, comprising:
a first electrode and a second electrode with a membrane disposed therebetween and in ionic communication with the first electrode and the second electrode;
a flow field consisting essentially of a sintered porous support member disposed in electrical and physical communication with the first electrode; and
a pressure assembly disposed in physical and electrical communication with the flow field.

21. The electrochemical cell of claim 20, wherein the support member further comprises a first portion adjacent the membrane and a second portion on a side of the first portion opposite the membrane, and wherein the second portion has a second portion porosity different from a first portion porosity.

22. The electrochemical cell of claim 20, wherein the second portion porosity is greater than the first portion porosity.

23. The electrochemical cell of claim 20, wherein the support member further comprises the first electrode.

24. The electrochemical cell of claim 20, wherein the support member is configured to support the membrane at pressures of greater than or equal to about 100 psi.

25. The electrochemical cell of claim 24, wherein the pressures are greater than or equal to 500 psi.

26. The electrochemical cell of claim 20, wherein the porous support member comprises a channel.

27. The electrochemical cell of claim 20, wherein the pressure pad assembly is a pressure pad.

28. A method for operating an electrochemical cell, comprising:
passing water through a sintered porous support member to a first electrode;
producing hydrogen ions and oxygen;
moving the hydrogen ions across a membrane to a second electrode, wherein there is a pressure differential across the membrane of greater than or equal to about 100 psi; and
forming hydrogen gas at the second electrode;
wherein the support member is disposed on a side of the membrane opposite the second electrode, wherein the support member comprises a first portion on first side of the support member proximate the membrane and a second portion disposed on a side of the first portion opposite the membrane, and wherein the second portion has a second portion porosity different from a first portion porosity.

29. A method for operating an electrochemical cell, comprising:
passing water through a flow field to a first electrode;
producing hydrogen ions and oxygen;
moving the hydrogen ions across a membrane to a second electrode, wherein there is a pressure differential across the membrane of greater than or equal to about 100 psi; and
forming hydrogen gas at the second electrode;
wherein the flow field consists essentially of a sintered porous support member disposed in electrical and physical communication with the first electrode, and wherein a pressure assembly is disposed in physical and electrical communication with the flow field.
